(19) United States
(12) Patent Application Publication
(10) Pub. No.: US 2009/0217367 A1
(43) Pub. Date: Aug. 27, 2009

(54) SSO IN VOLATILE SESSION OR SHARED ENVIRONMENT

(76) Inventors: James M. Norman, Pleasant Grove, UT (US); Cameron Mashayekhi, Salt Lake City, UT (US); Karl E. Ford, Highland, UT (US)

Correspondence Address: KING & SCHICKLI, PLLC, 247 NORTH BROADWAY, LEXINGTON, KY, 40507, US

(21) Appl. No.: 12/036,596

(22) Filed: Feb. 25, 2008

(51) Int. Cl. H04L 9/32

(52) U.S. Cl. 726/8

(57) ABSTRACT

Apparatus and methods utilize a single-sign-on (SSO) framework on one or more physical or virtual computing devices. During use, it is determined whether SSO credentials are for use in a volatile session and/or for use amongst an application suite or a plurality of applications. In the former, the SSO credentials are either made temporarily available in a memory of the computing devices, if relatively high security is desired, or a credential store and its contents are made available to a disk, if relatively low security is acceptable. In the latter, the SSO credentials are shared during authentication of a single user as individual applications of the application suite or the plurality of applications are used or started independently. Other features contemplate credential lifetime, the destruction of credentials, timing of application usage relative to credentials as well as retrofitting existing SSO services. Computer program products and computing interaction are also disclosed.

### FIELD OF THE INVENTION

Generally, the present invention relates to computing environments involving single-sign-on (SSO) experiences. Particularly, although not entirely, it relates to SSO credential usage in a volatile session, such as per a defined length of time, while a computer is on, etc., and or for use amongst applications of an application suite or a plurality of (un)related applications. Other features contemplate credential lifetime, destruction of credentials, timing of application usage, and prompting users Retrofitting existing SSO services and providing computer program products and computing interaction, to name a few, are still other aspects.

### BACKGROUND OF THE INVENTION

Newer computer operating systems such as Linux, Windows XP, or Windows Vista provide multiple credential stores for network client applications' usage. These credential stores usually are utilized to provide mechanisms for software applications to securely store credentials for the user, and retrieve them later for authentication to provide a single-sign-on (SSO) experience.

As is known in the art, certain software applications have authentication engines “enabled” to detect the existence of an SSO software installation within the operating system of a computing device and its availability during an SSO session to store and/or retrieve credentials actively. An example of one such application would be Novell's Groupwise eMail software or Novell's Network Client software. Another embodiment allows for “helper” software, provided by the SSO components installed on the operating system, to intercept authentication requests and dialogs by employing operating system available features to perform screen scraping (as it is commonly known) to capture credentials and store and retrieve user credentials for use. An example of such helper software is Novell's Secure Login. In turn, a hybrid approach utilizes the “enabled” software embodiment to perform SSO through the use of “helper” software in the middle. An example of this type of SSO software would be Novell's CASA brand software (Common Authentication Services Adapter), Novell's Secure login, or Novell's SecretStore. In still another embodiment, a system administrator or the user pre-populates a SSO credential store.

In any embodiment, however, there is no present mechanism that allow applications to share a set of common credentials for authentication purposes. In turn, convenience and efficiency is lost since modification of credentials per a given application translates into needing to updating the credentials per other applications. In an application suite environment, it is known that multiple software components can be used or started independently of one another. However, the suite is incapable of acquiring knowledge that a user might have already started other components of the software and has already authenticated to one or more other components. In turn, user effort in coordinating credentials is high.

Also, it presently exists that SSO sessions might be temporarily undertaken at a borrowed computing device, e.g., a computing kiosk, for work, such as for twenty minutes in a lobby, two days during a hotel stay. In such scenarios, however, no present mechanism safeguards the credentials, after use, other than manual destruction by users or applications. In other words, existing SSO frameworks maintain a persistent SSO life cycle beyond the life of a user SSO session. Further, if the machine is borrowed by multiple users each having their own need to engage in an SSO session, nothing is available to allocate SSO credentials amongst the pluralities of users, each with their own safeguarding concerns.

Ultimately, nothing in existing SSO frameworks provides means to support shared credentials in a volatile session for security or other considerations or in shared hardware or software environments.

In view of these various problems, there is need in the art of credentialing for SSO experiences to share credentials. There is also a need to safeguard SSO credentials in a volatile session, including the destruction of credentials, perhaps. Contemplating shared credentials and volatile sessions are not mutually exclusive, needs in the art extend to overcoming both problems individually and collectively. In that many computing configurations already have existing SSO technology, it is further desirable to leverage existing configurations by way of retrofit technology, thereby avoiding the costs of providing wholly new products. Taking advantage of existing frameworks, such as the CASA (Common Authentication Service Adapter) software offering by Novell, Inc., the common assignee of this invention, is another feature that optimizes existing resources. Any improvements along such lines should further contemplate keeping user interaction to a minimum, for otherwise, the SSO advantages are minimized or lost) and to maintain good engineering practices, such as automation, relative inexpensiveness, stability, ease of implementation, security, etc.

### SUMMARY OF THE INVENTION

The foregoing and other problems become solved by applying the principles and teachings associated with the hereinafter-described SSO in volatile session or shared environment. At a high level, methods and apparatus utilize a single-sign-on (SSO) framework on one or more physical or virtual computing devices. During use, it is determined whether SSO credentials are used in a volatile session, such as definite length of time, while a computer is on, etc., and/or for use amongst applications of an application suite or a plurality of (un)related applications. In the former, the SSO credentials are either made temporarily available in a memory of the physical or virtual computing devices, if relatively high security is desired, or a credential store and its contents are made available to a disk of the computing devices, if relatively low security is acceptable. In the latter, the SSO credentials are shared during authentication of a single user as individual applications of the application suite or the plurality of applications are used or started independently.

In a computing system embodiment, the invention may be practiced with secret stores; a client workstation; and a server arranged as part of pluralities of physical or virtual computing devices, including executable instructions for undertaking the foregoing methodology. Computer program products are also disclosed and are available as a download or on a computer readable medium. The computer program products are also available for installation on a network appliance, such as a server, on a client workstation, or as retrofit technology with a SSO service such as Novell's CASA architecture.

In still other embodiments, credential lifetime is contemplated as is the destruction of credentials, timing of application usage relative to credential life and/or prompting users to refresh credentials or re-authenticate.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for SSO in volatile sessions and/or shared environments;

FIGS. 2 and 3 include a flow chart and diagrammatic view in accordance with the present invention for SSO credentials relative to an application suite or a plurality of (un)related applications;

FIGS. 4-7 include a flow chart and diagrammatic views in accordance with the present invention for SSO credentials in a volatile session; and

FIGS. 8 and 9 are flow charts in accordance with the present invention contemplating various lifetimes for SSO in volatile sessions and/or shared environments.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for SSO in volatile sessions and shared environments, sharing being of the type related to hardware, software or both.

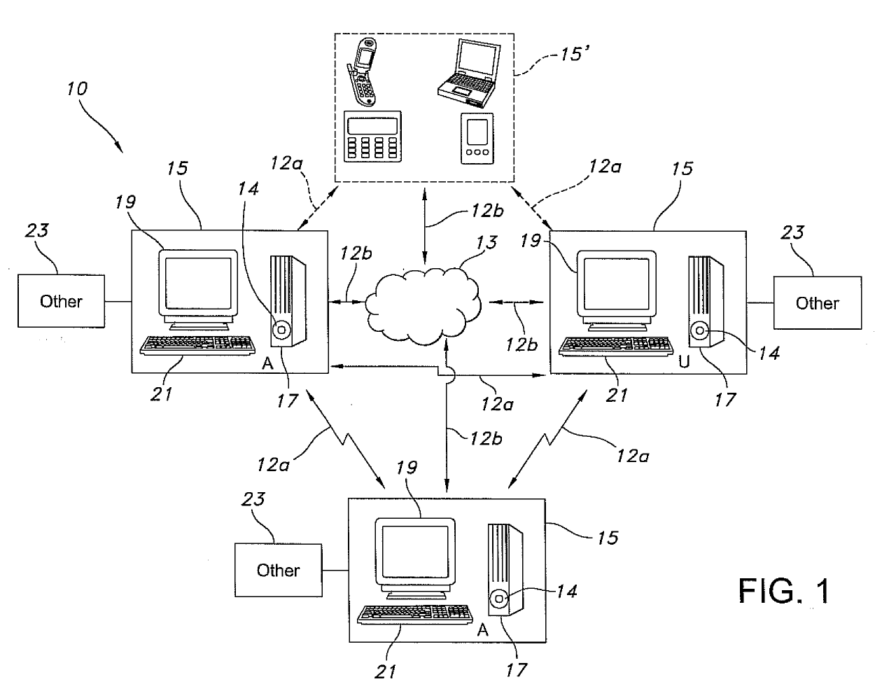

With reference to FIG. 1, a representative computing environment 10 for practicing certain or all aspects of the invention includes one or more computing devices 15 or 15′ arranged as individual or networked physical or virtual machines, including clients or hosts arranged with a variety of other networks and computing devices. In a traditional sense, an exemplary computing device typifies a server 17, such as a grid or blade server. Brand examples include, but are not limited to, a Windows brand Server, a SUSE Linux Enterprise Server, a Red Hat Advanced Server, a Solaris server or an AIX server. Alternatively, it includes a general or special purpose computing device in the form of a conventional fixed or mobile (e.g., laptop) computer 17 having an attendant monitor 19 and user interface 21. The computer internally includes a processing unit for a resident operating system, such as DOS, WINDOWS, MACINTOSH, LEOPARD, VISTA, UNIX, and LINUX, to name a few, a memory and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer computing device, a broadcast antenna, a web server, an AJAX client, a grid-computing node, a virtual machine, a web service endpoint, a cellular phone, or the like. The other items may also be stand alone computing devices 15 in the environment 10 or the computing device itself.

In either, storage devices are contemplated and may be remote and/or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available for installation as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download of executable instructions resident with a downstream computing device or readable media received from an upstream computing device or readable media, a download of executable instructions resident on an upstream computing device or readable media awaiting transfer to a downstream computing device or readable media, or any available media, such as RRAM, ROM, EEPROM, CD-ROM, DVD, or other optical disk storage devices, magnetic disk storage devices, floppy disks, or any other physical medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include sellers, routers, peer devices, modems, T# lines, satellites, microwave relays or the like. The connections may also be local area networks (LAN), metro area networks (MAN), and/or wide area networks (WAN) that are presented by way of example and not limitation. The topology is also any of a variety, such as ring, star, bridged, cascaded, meshed, or other known or hereinafter invented arrangement.

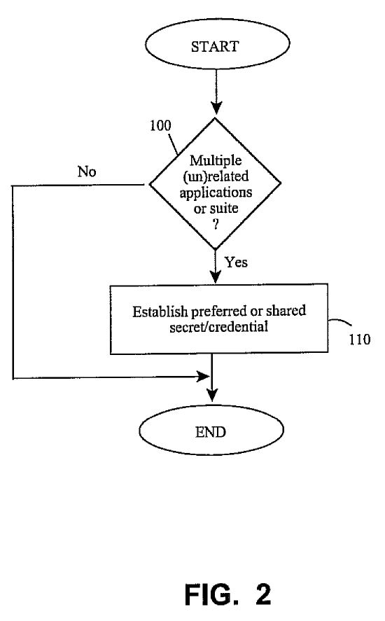

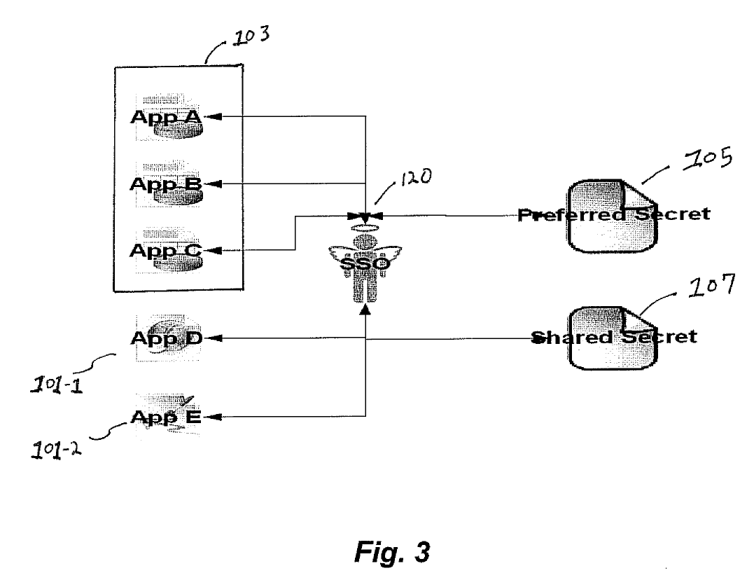

With the foregoing representative computing environment as backdrop, FIGS. 2 and 3 show a representative high-level embodiment for sharing SSO credentials. At step 100, it is determined whether more than one application 101-1, 101-2 or a suite of applications 103 has need or could benefit from commonality in a user's SSO credentials. If so, a preferred or shared secret or credential 105, 107 is established, at step 110, to improve usability, for example. Among other things, a first embodiment allows multiple applications to share a common credential known as preferred credential 105 to perform authentication of a user. In this method, convenience and efficiency is garnered because the preferred credential is securely shared which allows for storage of one set of credentials in use by these applications. Subsequently, if one of these components (App A) modified the credential, then the need for performing the update at the authentication point on all of the other applications (App B and App C) is eliminated. Instead, the SSO executable code 120 interfaces between the applications and the preferred secret.

In another embodiment of sharing credentials, a situation exists where there is an application suite that has multiple software components that can be used or started independently of one another (e.g., the Microsoft Office suite includes independently started/used applications like Microsoft Excel, Word, Power Point, etc.). However, these components are presently incapable of acquiring knowledge that the user might have already started one component in lieu of another, or the ability to pass the authentication credentials securely to the other component upon feature invocation. Thus, the present design overcomes these obstacles.

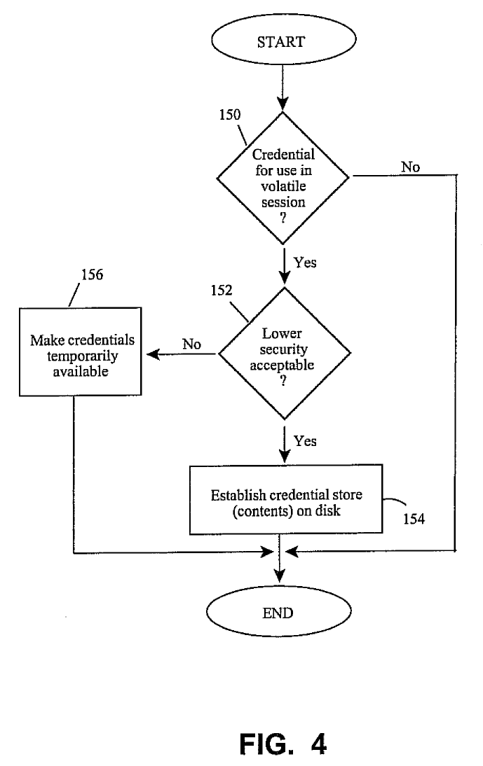

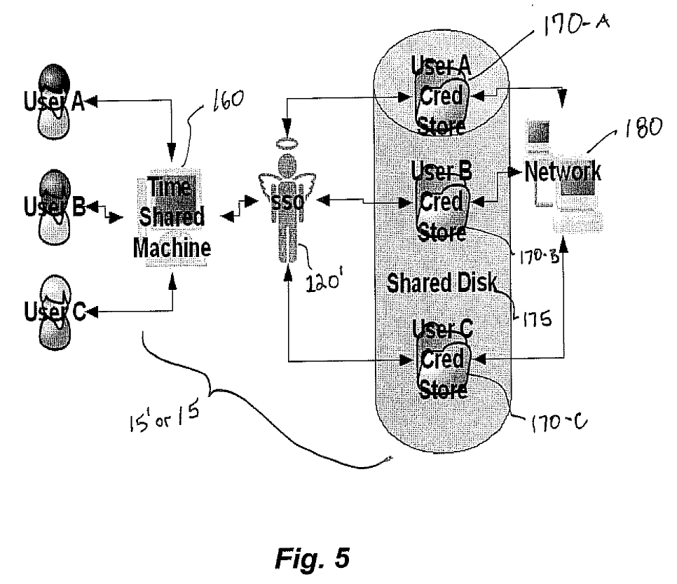

With reference to FIGS. 4-6, multiple applications share credentials as explained above, but with an understanding of the lifetime of the credential. As before, the prior art lifetime of credentials extends beyond the life of a user SSO session and persists until such time as it is manually removed by the user or application from a credential store. However, the following contemplates using credentials in volatile sessions, such as upon an instance of determining it at step 150, representatively undertaken by presenting a user a question on a computer monitor during network login. In this regard, volatile sessions are those that might exists when a computing device being used by a user is not owned by the user, and so the usage is temporary e.g., a predetermined or fixed time (20 minutes), from computer turn-off to computer turn-off, etc. One example of such an environment includes computing kiosks where users A, B, and C take temporary ownership of a shared computing device 160 in a hotel or airport lobby, etc.

At step 152, it is then determined what is an acceptable level of security for the user per their forthcoming SSO session. Relatively, this can consist of high, low, or medium, as prompted of the user also during login. Naturally, other security levels are known and can be substituted here. Upon answering, one scheme contemplates relatively low security, while another contemplates security higher than the low security, or a relatively high security level.

To the extent the user, policy or application deems relatively low security is acceptable, an entirety or substantial entirety of a credential store 170 for individual users A, B, or C can be downloaded or transferred from elsewhere upon authentication of the user to the network 180 and the workstation 160 to make SSO available during the session on the shared machine. In this scheme, the credentials are persistent and are stored on another server or workstation of the network 180, but are made available to the relatively permanent storage, e.g., disk 175, hard disk drive, etc., of the shared machine 160. The executable code 120′ of the SSO software would be required to be available on the shared machine and should clean up, e.g., destroy, the confidential data of the credential store upon the termination of an individual user's SSO session. Similarly, other users would have their credential store and contents made available to the shared machine that are cleaned-up upon the termination of their SSO sessions. Due to relatively lower security in this scheme, however, it is appreciated that catastrophic failures might leave otherwise sensitive residue data on the shared machine that can possibly be exploited by others having access to the shared machine.

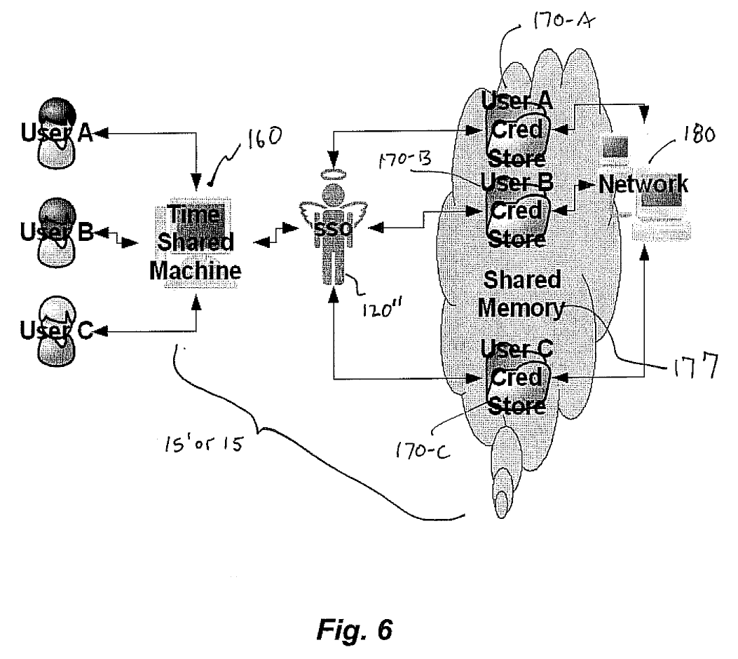

In another scheme, FIG. 6 and step 154, FIG. 4, the same volatile session and security level assessment as the first scheme is employed, but to satisfy a higher level of security requirements, the user's credentials are only made available in a volatile manner. In other words, the user's credential store, contents, etc. 170, is only made temporarily available, such as by saving to memory 177 of the shared machine 160, and not to its disk. As a result, upon termination of a user's SSO session, or in the case of catastrophic failures, no sensitive residue data will be left on the hard drive of the shared machine. Also, the executable code of the SSO software 120″ locally cleans-up or destroys any individually user's credentials upon termination of the SSO session.

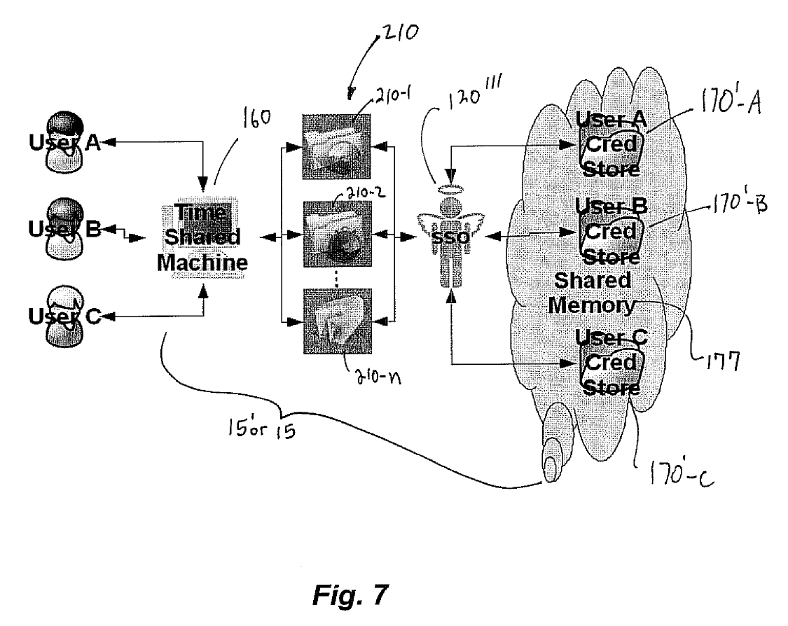

With reference to FIG. 7, an alternate embodiment along the line of aforementioned schemes is that of using a non-persistent set of credentials, including the need to share credentials by a plurality of applications 210 that are arranged either in a suite or not. In other words, this embodiment contemplates both a shared set of credentials amongst pluralities of applications and a shared machine, such as in a volatile session.

In one version, a relatively high security level, volatile shared environment contemplates the simple downloading of secrets from a back-end credential store, in a secure manner, and loading them locally in a secure memory 177 for the duration of a user's (A, B or C) SSO session.

In another, a credential that is shared by applications 210, and session-based, is added when a first application 210-1 in a grouping of applications 210 is started and the user is prompted for credentials, e.g., those from User A's Credential store 170′-A. This set of credentials is then removed from memory 177 when User A turns off the workstation 15, 15′, signs off from the session, or the last application 210-n in the group of applications 210 is terminated. To clarify, the first invoked application in the group of applications, e.g., 210-1, collects the user's credential and authenticates the user. Upon successful authentication, it stores the credentials in a volatile store, e.g., memory 177 as a shared credential for possible use by other applications in the suite or group, e.g., 210-2 . . . 210-n. In turn, these types of shared credentials can either be aged for expiration for timely removal from memory or removed upon termination of the last-running application in the group. In the event the SSO session continues, in the age expiration case, the user will be prompted to refresh the credential, or in the last-running application case, upon invocation of a new application in the grouping the user will be prompted to authenticate and the shared credential will be stored for subsequent use.

As a working example, Novell's GroupWise, GroupWise Address Book, and GroupWise Messenger program products all require user credentials in order to authenticate a user to their respective services. Typically, all three require the same credential values to authenticate, but could, in some instances, be different. Hence, a SSO framework could be configured to allow the applications in the Novell suite to share the same credentials. Doing so means that the credential must exist for a period of time. For SSO to work effectively, that period of time must be at least as long for each application to authenticate. Once the first application collects a credential from the user, that credential must be available for the second application sharing this credential and so on.

In other words, the two versions or embodiments include the following. The first situation is one where a plurality of applications share a single preferred credential in a volatile memory based credential store. The second situation is one where a suite of applications share the same set of credentials in a volatile memory based credential. A SSO session's life span or an application's life span, during the SSO session, is then used to determine the life cycle of the credential in the credential store for use by the other applications in the suite or an aging scheme will be used to expire/destroy the credential in the store. In either, after the credentials are collected and stored in the SSO framework, they remain available until the last application in the suite terminates or age expiration is applied.

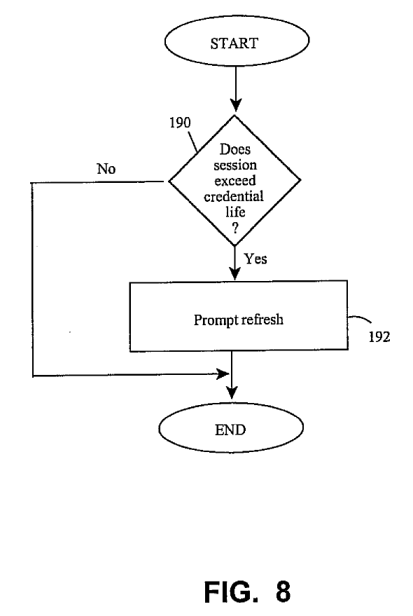

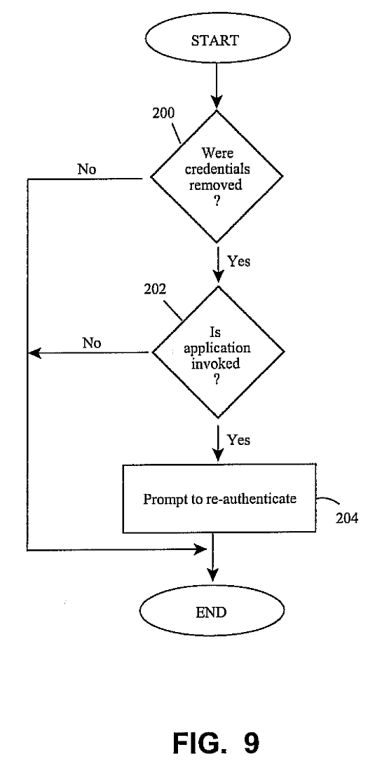

To the extent the lifetime of the user's SSO session on the computing device outlasts the credential's lifetime, the user will be prompted to refresh their credentials, steps 190, 192, FIG. 8. To the extent the user's credentials were removed due to termination of a last application in the group (of applications) being closed, shut down, etc., step 200, FIG. 9, and sometime later one of the applications in the group of applications was invoked again, step 202, the invocation would result in prompting the user for authentication again, step 204. In either, however, termination of the SSO session or a catastrophic failure taking place results in no sensitive residue data being left on the shared machine because of the use of the shared machine's memory versus disk usage. Advantageously, this limits security vulnerability.

Various specific SSO frameworks for use with the invention include, but are not limited to, SecretStore, Firefox Password Manager, Gnome Keyring, KDE Wallet, CASA and miCASA. In more detail of one embodiment, Novell's CASA is a common authentication and security package that provides a set of libraries for application and service developers to enable single sign-on for an enterprise network. Version 1.7, for example, provides a local, session-based credential store (called miCASA) that is populated with desktop and network login credentials. A CASA manager serves as a user interface module, whereby users interface with their credentials in the various stores.

Within Novell's CASA Manager, it is contemplated that some or all of the foregoing will be configured using an SSO management utility. As anticipated, the CASA Manager, in an administrative mode, will allow a user with administrative privileges to set up the policy of SSO software (CASA) to only run in memory of a computing device without needing to save secrets on the hard disk of the computing device. In addition, it is possible to set expiration times for secrets. Depending on configuration for back-end availability, or the lack of it, the SSO software 120 can be configured to retrieve secrets from a back-end secret store or to operate without a back-end secret store when in a software suite mode of operation where a group of software components are enabled or configured to use a same secret. It is expected that this configuration will use encryption and save using a key-encryption based on a password provided by the system administrator to save these options for the default behavior of the SSO Software. Stated differently, once the administrator is authenticated to the workstation and the SSO software framework is operationally, the SSO management utility allows the administrator to enter credentials for storage, delete them, and edit them. The utility then allows the configuration of which credential is to be shared amongst applications, and/or the administrator to configure a group, or a suite, of applications using a shared credential. All of these options allow the administrator to configure the SSO software to a level of granularity that is defined by the security policies of the computing environment.

In an alternate embodiment, another scheme of usage is that of a user utilizing a computing device in the form of a disk-less workstation whereby the security policies do not allow for the user to have sensitive data such as credentials to be stored on disk. In this scenario, the SSO software will likely only run in a mode whereby the secrets are stored in a volatile memory-based credential store that, depending on the user having a back-end secret store or not, can operate automatically in one of the modes above without any need for a previous configuration.

During the use of the credential, the SSO framework determines the use of credential by its access, either being created or retrieved. The access of a credential is mapped to the Process ID of a process accessing the credential. From this ID, the framework determines the full path of the executable file name. If the application under consideration is configured as a member of an application suite, the PID is recorded as active for this credential. The SSO framework then monitors the running processes in the system. Either through the application stop event, or by a background thread, the SSO framework determines if a given credential should be destroyed by removal from memory. If all of the “active” PIDs terminate, the SSO framework removes the given credential.

Finally, one of ordinary skill in the art will recognize that additional embodiments are also possible without departing from the teachings of the present invention. This detailed description and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment utilizing a single-sign-on (SSO) framework on one or more physical or virtual computing devices, a method of utilizing SSO credentials, comprising:
determining whether the SSO credentials are for use in a volatile session of the one or more physical or virtual computing devices;
if so, retrieving the SSO credentials from a remote location; and
making the SSO credentials only temporarily available in a memory of the one or more physical or virtual computing devices, the SSO credentials not being available to a disk of the one or more physical or virtual computing devices.

2. The method of claim 1, further including locally destroying the SSO credentials.

3. The method of claim 1, further including determining an acceptable security level regarding of the SSO credentials being made available to the one or more physical or virtual computing devices.

4. The method of claim 3, wherein the determining the acceptable security level further includes determining a relatively high security.

5. The method of claim 1, further including sharing the SSO credentials amongst an application suite or a plurality of applications.

6. In a computing system environment utilizing a single-sign-on (SSO) framework on one or more physical or virtual computing devices, a method of utilizing SSO credentials, comprising:
determining whether the SSO credentials are for use in a volatile session of the one or more physical or virtual computing devices;
if so, determining an acceptable security level regarding of the SSO credentials being made available to the one or more physical or virtual computing devices;
retrieving the SSO credentials; and
making the SSO credentials available at the one or more physical or virtual computing devices.

7. The method of claim 6, wherein the making the SSO credentials available further includes making the SSO credentials only temporarily available in a memory of the one or more physical or virtual computing devices.

8. The method of claim 6, wherein the making the SSO credentials available further includes making a credential store and contents available to a disk of the one or more physical or virtual computing devices.

9. In a computing system environment utilizing a single-sign-on (SSO) framework on one or more physical or virtual computing devices, a method of utilizing SSO credentials, comprising:
determining whether the SSO credentials are for use in a volatile session of the one or more physical or virtual computing devices;
if so, retrieving the SSO credentials; and
making a credential store and the SSO credentials available to a disk of the one or more physical or virtual computing devices.

10. The method of claim 9, further including determining an acceptable security level regarding of the SSO credentials being made available to the one or more physical or virtual computing devices.

11. The method of claim 10, wherein the determining the acceptable security level further includes determining a relatively low security.

12. The method of claim 9, further including sharing the SSO credentials amongst an application suite or a plurality of applications.

13. In a computing system environment utilizing a single-sign-on (SSO) framework on one or more physical or virtual computing devices, a method of utilizing SSO credentials, comprising:
determining whether the SSO credentials are for use amongst an application suite or a plurality of applications; and
if so, sharing the SSO credentials during authentication of a single user as individual applications of the application suite or the plurality of applications are used or started independently.

14. The method of claim 13, further including determining whether the SSO credentials are for use in a volatile session of the one or more physical or virtual computing devices.

15. The method of claim 14, further including making the SSO credentials only temporarily available in a memory of the one or more physical or virtual computing devices, the SSO credentials not being available to a disk of the one or more physical or virtual computing devices.

16. The method of claim 15, further including locally destroying the SSO credentials.

17. The method of claim 14, further including making the SSO credentials available to a disk of the one or more physical or virtual computing devices.

18. The method of claim 141, further including retrieving the SSO credentials from a location remote the one or more physical or virtual computing devices.

19. The method of claim 13, further including determining an acceptable security level regarding the sharing of the SSO credentials.

20. The method of claim 19, wherein the determining the acceptable security level further includes determining a relatively high or low security.

21. A computer program product available as a download or on a computer readable medium having executable instructions for installation on one or more physical or virtual computing devices utilizing a single-sign-on framework, comprising:
a first component for receiving an indication from a user of the one or more physical or virtual computing devices regarding one of whether the SSO credentials are for use in a volatile session of the one or more physical or virtual computing de-vices and whether the SSO credentials are for use amongst an application suite or a plurality of applications;
a second component for making the SSO credentials only temporarily available in a memory of the one or more physical or virtual computing devices upon the receiving the indication from the user regarding usage in the volatile session, the SSO credentials not being available to a disk of the one or more physical or virtual computing devices; and
a third component for sharing the SSO credentials during authentication of a single user as individual applications of the application suite or the plurality of applications are used or started independently, the third component for sharing upon the receiving the indication from the user regarding the SSO credentials being used amongst the application suite or the plurality of applications.

22. The computer program product of claim 21, further including a fourth component for receiving an indication from the user regarding an acceptable security level regarding of the SSO credentials being made available to the one or more physical or virtual computing devices.
